(19) United States
(12) Patent Application Publication
(10) Pub. No.: US 2002/0103693 A1
(43) Pub. Date: Aug. 1, 2002

(54) System and method for aggregating and analyzing feedback

(76) Inventors: Horst Bayer, Sunnyvale, CA (US); Sebastian Gierich, Buchenbach (DE); Holger Kasten, Sunnyvale, CA (US); Stephan Meyer, Westfield, NJ (US)

Correspondence Address: Siemens Corporation, Attn: Elsa Keller, Legal Administrator, Intellectual Property Department, 186 Wood Avenue South, Iselin, NJ, 08830, US

(21) Appl. No.: 09/773,021

(22) Filed: Jan. 30, 2001

(51) Int. Cl. G06F 17/60

(52) U.S. Cl. 705/10; 705/7

(57) ABSTRACT

A system and method for aggregating and analyzing feedback operates by receiving a first set of travel information including information identifying a traveler, an itinerary of the traveler, and at least one travel service provider scheduled to provide services to the traveler. The system automatically generates a feedback request based on the first set of travel information and requests specific feedback regarding the at least one travel service provider. The feedback request is transmitted to the traveler for completion, and the system receives the feedback information from the traveler. The system then operates to analyze the feedback information received from the traveler.

### BACKGROUND OF THE INVENTION

1. Field of the Invention

The present invention relates generally to customer service systems and more particularly, to a method for aggregating and analyzing customer feedback.

2. Description of the Related Art

Travel is an important aspect of doing business in today's economy. Entities from the United States and around the world do business with customers and partners in other countries, from Azerbaijan to Zimbabwe. As a result, travel is becoming an increasingly large cost item for many entities. It is desirable for businesses to reduce, or at least manage, the costs that they spend on corporate travel expenses.

Corporations and travel service providers have responded to these increased costs by implementing corporate travel programs which dictate travel policies for employee-travelers (e.g., limiting business class air travel to overseas flights, or only using particular preferred providers to receive a bulk discount). Tools have been developed which help to automatically enforce these travel policies, resulting in reduced travel costs. Other tools have been developed which integrate travel planning services with back office functions such as accounting and budgeting. This provides corporate travel offices with insight into the costs associated with travel.

Simple enforcement of travel policies and oversight of travel costs is inadequate to allow proactive and aggressive management of a corporate travel program. It would be desirable to provide an ability to for corporate travel departments to better manage their relationship with individual travel service providers who provide travel services to the corporate travel program.

It is also desirable for businesses to spend their corporate travel budgets wisely; that is, with travel providers who provide travel services which are appropriate in terms of cost, service, and quality.

Increased costs are not the only way that travel impacts businesses. Travel is also a drain on time. Employees are spending more of their valuable time traveling. Businesses wish to ensure that employees are satisfied with their travel experiences, and that employees are traveling in the most efficient and enjoyable way possible. Some travel agencies, such as Carlson Wagonlit®, conduct optional surveys of customers at the end of each telephone call for booking travel plans. While this is helpful to the travel agency, it does not provide any useful feedback to corporate travel providers. Further, because it is performed before travel is commenced, it does not allow the traveler to provide detailed feedback regarding his or her experiences during travel. It is desirable to provide a system and method which allows businesses to track, manage, and act on employee-traveler complaints and feedback regarding different travel service providers after the services have been rendered. It is also desirable to provide a system and method which ensures that travelers receive feedback and responses to their complaints and comments regarding travel service providers.

### SUMMARY OF THE INVENTION

In order to address the above problems, the present invention provides a system to aggregate feedback, which includes receiving a first set of travel information including information identifying a traveler, an itinerary of the traveler, and at least one travel service provider scheduled to provide services to the traveler. The system automatically generates a feedback request based on the first set of travel information and requests specific feedback regarding the at least one travel service provider. The feedback request is transmitted to the traveler for completion, and the system receives the feedback information from the traveler. The system then operates to analyze the feedback information received from the traveler.

In one embodiment, the system analyzes the feedback information by identifying any complaint information which is provided by the traveler, and by acting on the complaint information to resolve the traveler's complaint.

In one embodiment, the feedback request includes one feedback request form for each travel service provider and one summary feedback request form for the trip as a whole.

In another embodiment, a computer-implemented method for aggregating feedback is provided, the method including receiving a first set of travel information including information identifying a traveler, an itinerary of said traveler, and a plurality of travel service providers scheduled to provide services to the traveler. The method includes generating a feedback request form for each of the plurality of travel service providers, requesting specific feedback based on each of the plurality of travel service providers. A summary feedback request form is also generated, requesting general feedback for the itinerary and each of the plurality of travel service providers. All of the feedback request forms and summary feedback request form are transmitted to the traveler, and feedback information is received from the traveler, including completed ones of the feedback request forms and the summary feedback request form. The feedback information received from the traveler is then analyzed.

According to other embodiments of the invention, an apparatus for aggregating feedback is provided including means for receiving a first set of travel information including information identifying a traveler, an itinerary of the traveler, and at least one travel service provider scheduled to provide services to the traveler. Means for automatically generating a feedback request based on the first set of travel information and requesting specific feedback regarding the at least one travel service provider are also included, as are means for transmitting the feedback request to the traveler. Means for receiving feedback information from the traveler, and means for analyzing the feedback information received from the traveler are also provided.

According to yet another embodiment of the present invention, a machine-readable medium having stored thereon data representing sequences of instructions is provided. The sequences of instructions, when executed by a processor, cause the processor to receive a first set of travel information including information identifying a traveler, an itinerary of the traveler, and at least one travel service provider scheduled to provide services to the traveler. The sequences of instructions cause the processor to automatically generate a feedback request based on the first set of travel information and requesting specific feedback regarding the at least one travel service provider; transmit the feedback request to the traveler; receive feedback information from the traveler; and analyze the feedback information received from the traveler.

By virtue of the above features, the present invention, in some aspects, allows businesses to more proactively manage their travel costs and track, manage, and act on employee-traveler complaints and feedback regarding particular travel service providers.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a block diagram of a system architecture according to one embodiment of the present invention.

FIG. 2 is a block diagram illustrating an internal architecture of a customer service controller according to one embodiment of the present invention.

FIG. 3 illustrates a tabular representation of a portion of a traveler database according to one embodiment of the present invention.

FIG. 4 illustrates a tabular representation of a portion of a service provider database according to one embodiment of the present invention.

FIG. 5 illustrates a tabular representation of a portion of a itinerary database according to one embodiment of the present invention.

FIG. 6 illustrates a tabular representation of a portion of a feedback database according to one embodiment of the present invention.

FIG. 7 is a flow diagram of process steps to collect feedback information according to one embodiment of the present invention.

FIG. 8 is a flow diagram of process steps to analyze feedback information according to one embodiment of the present invention.

FIGS. 9A-9E are outward views of user interfaces for receiving traveler feedback according to embodiments of the invention.

### DETAILED DESCRIPTION

Embodiments of the present invention are directed to systems and methods allowing the aggregation, collection, and analysis of customer feedback. As used herein, “corporations” or “businesses” are generically used to refer to entities which utilize travel services, and may include other entities such as governments, schools, or other institutions.

### System Overview

Typical corporate travel programs utilize the services of a number travel service providers (e.g., travel agents, airlines, hotels, car rental companies) to provide travel services to employees who are traveling. When an employee-traveler has made travel plans, he or she typically receives a travel itinerary. Embodiments of the present invention take advantage of this itinerary by having an electronic copy sent to a central customer service controller. The itinerary typically lists each of the travel service providers who are to provide travel services to the employee on his or her trip, and also lists the trip start and end dates. The central customer service controller uses this information to generate feedback requests which are sent to the employee upon completion of his or her trip, soliciting detailed feedback regarding the employee's experiences with each of the travel service providers. Embodiments of the present invention, as will be described below, generate these requests in a manner which makes it easy and efficient for the employee to respond with detailed information. If the employee has particular complaints or comments which require further resolution, the customer service controller ensures that this is done properly. The customer service controller also may function to communicate complaints or other feedback to individual travel service providers, and may also act as an electronic message board, posting comments for other employees to review. The result is a system which allows corporate travel groups to proactively manage the relationship with individual travel service providers and to ensure that employee-travelers are satisfied with the services that are provided.

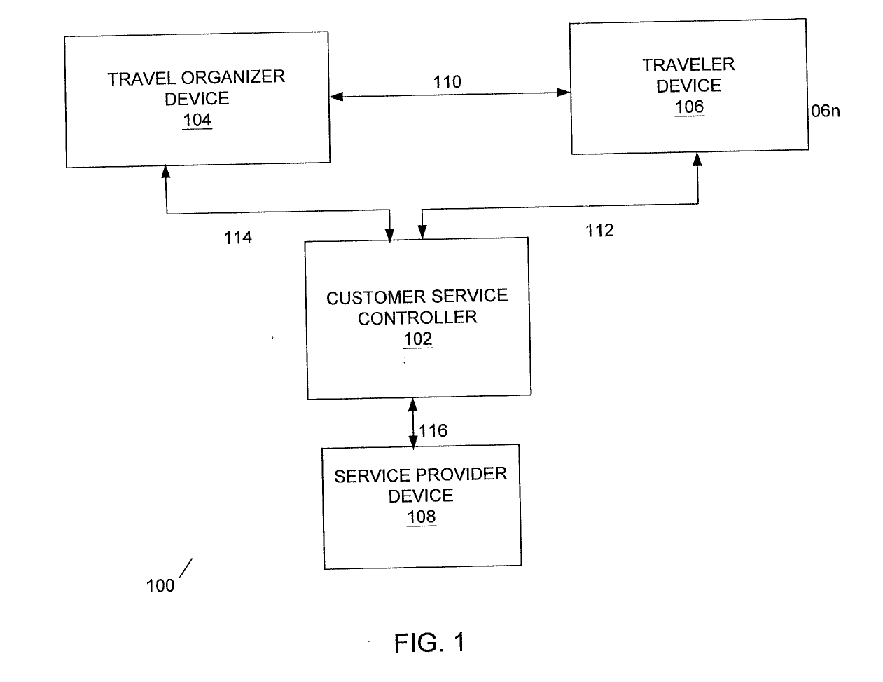

Turning now in detail to the drawings, FIG. 1 is a block diagram of a system 100 for aggregating and analyzing feedback according to one embodiment of the present invention where features of the present invention are used in a travel services environment. In the depicted embodiment, system 100 includes a customer service controller 102 in communication with a travel organizer device 104, a traveler device 106, and a travel service provider device 108. The functionality and operation of each of these devices will be described below. It should be understood that many other architectures, including a single stand-alone device (e.g., a travel kiosk located in a corporate travel department), may be used to implement features of the invention. Throughout this disclosure, each of the elements 104, 106 and 108 will be referred to as either devices or as the entity operating the device (e.g., traveler device 106 may also be used to refer to an individual traveler).

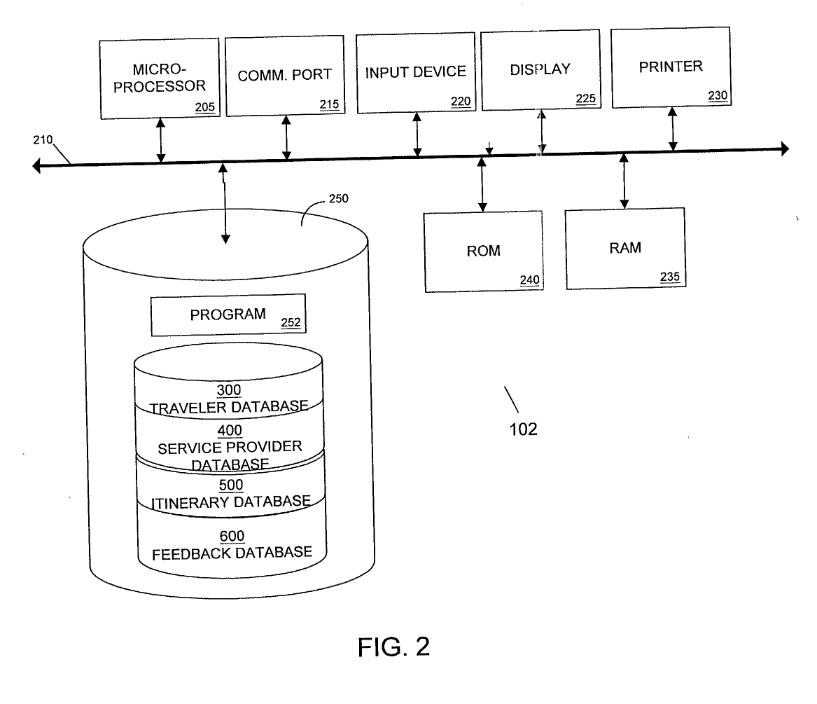

Customer service controller 102, travel organizer device 104, traveler device 106 and travel service provider device 108 may be any devices capable of performing the various functions described herein. In one embodiment, customer service controller 102 is configured as a server in a manner described below in conjunction with FIG. 2. In some embodiments, travel organizer device 104, traveler device 106 and service provider device 108 are computing devices, such as: a Personal Computer (PC), a portable computing device such as a Personal Digital Assistant (PDA), a wired or wireless telephone, a one-way or two-way pager, a kiosk (e.g., a travel services kiosk located at an airport terminal), an interactive television device, or any other appropriate storage and/or communication device.

As depicted in FIG. 1, each of the devices are in communication over communication links 110, 112, 114 and 116. These communication links are used for illustration, and need not be direct or dedicated communications links between the depicted devices. In one currently preferred embodiment, each of the devices (customer service controller 102, travel organizer device 104, traveler device 106, and travel service provider device 108) may communicate via a communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet or an extranet. Moreover, as used herein, communications include those enabled by wired or wireless technology.

For simplicity, system 100 as depicted shows individual devices 102, 104, 106, 108; however, any number of these devices may be included in system 100. For example, in an example embodiment where system 100 is used in a corporate travel environment, a large number of traveler devices 106 (operated, e.g., by or on behalf of employee-travelers) will be in communication with one or more customer service controllers 102 operated by or on behalf of a corporate travel department. Similarly, a large number of travel service provider devices 108 (e.g., operated by or on behalf of airlines, hotels, car rental companies, or the like) and travel organizer devices 104 (e.g., operated by or on behalf of travel agencies) will also be in communication with one or more customer service controllers 102.

In one embodiment of the present invention, a traveler device 106 communicates with a remote, Web-based customer service controller 102 (e.g., a server) via the Internet or via some other network such as a corporate intranet. Although some embodiments of the present invention are described with respect to information exchanged using a Web site, according to other embodiments information can instead be exchanged, for example, via: a telephone, an Interactive Voice Response Unit (IVRU), electronic mail, a WEBTV® interface, a cable network interface, and/or a wireless communication system. Travel organizer device 104 and travel service provider device 108 may communicate with customer service controller 102 in a similar manner.

Note that the devices shown in FIG. 1 need not be in constant communication with each other. For example, traveler device 106 may only communicate with customer service controller 102 via the Internet when appropriate (e.g., when the traveler's PC connects to an Internet Service Provider (ISP) and the PC's Web browser is directed to a Website operated by customer service controller 102). Note also that the functions of one or more of the devices of FIG. 1 may be incorporated in a single device (e.g., a customer service kiosk may act as both a customer service controller 102 and a travel organizer device 104).

### Customer Service Controller

FIG. 2 is a block diagram of the internal architecture of one embodiment of customer service controller 102. A similar architecture may be used for one or more of the other devices in system 100. Customer service controller 102 may be operated by or on behalf of a number of different entities desiring to aggregate, analyze, and utilize feedback using techniques of the present invention. For example, customer service controller 102 may be operated by or on behalf of a corporation which has an active corporate travel program. As another example, customer service controller 102 may be operated by or on behalf of a travel services company which offers corporate travel programs to companies.

In the embodiment illustrated in FIG. 2, customer service controller 102 includes a microprocessor 205 in communication with a communication bus 210. Microprocessor 205 may be an Intel Pentium®, RISC-based, or other type of processor and is used to execute processor-executable process steps so as to control the elements of customer service controller 102 to provide desired functionality. Many other types of computing hardware may be used to perform the functions of server 102, including, but not limited to, a mainframe, a workstation, a network of devices, or any combination of one or more of the foregoing.

Also in communication with communication bus 210 is a communication port 215. Communication port 215 is used to transmit data to and to receive data from external devices. Communication port 215 is therefore preferably configured with hardware suitable to physically interface with desired external devices and/or network connections. In one embodiment, requests for Web pages and user interfaces providing instructional information according to the invention are received from and transmitted to client devices 300 over communication port 215.

Input device 220, display 225 and printer 230 are also in communication with communication bus 220. Any known input device may be used as input device 220, including a keyboard, mouse, touch pad, voice-recognition system, or any combination of these devices. Input device 220 may be used by a user to input search terms, to select search results, and to select an alternative media indicator.

Display 225, which may be an integral or separate CRT display, flat-panel display or the like, is used to output graphics and text to a user in response to commands issued by microprocessor 205. Such graphics and text may comprise a user interface as described herein. Printer 230 is an output device that produces a hardcopy of data using ink-jet, thermal, dot-matrix, laser, or other printing technologies. Printer 230 may be used to produce a hardcopy of instructional text corresponding to a search result according to embodiments of the invention.

A random access memory (RAM) 235 is connected to communication bus 210 to provide microprocessor 205 with fast data storage and retrieval. In this regard, processor-executable process steps being executed by microprocessor 205 are typically stored temporarily in RAM 235 and executed therefrom by microprocessor 205. A read-only memory (ROM) 240, in contrast, provides storage from which data can be retrieved but to which data cannot be stored. Accordingly, ROM 240 is used to store invariant process steps and other data, such as basic input/output instructions and data used during system boot-up or to control communication port 215.

Microprocessor 205 is also in communication with a storage device 250. Storage device 205 may comprise any appropriate information storage device, including combinations of magnetic storage devices (e.g., magnetic tape and hard disk drives), optical storage devices, and/or semiconductor memory devices such as RAM devices and ROM devices.

Storage device 250 stores a program 252 for controlling microprocessor 205. Microprocessor 205 performs instructions of program 252, and thereby operates in accordance with the present invention. Program 252 may also function as a Web server allowing customer service controller 102 to receive and to transmit data using an appropriate data transmission protocol, such as the Hypertext Transfer Protocol (HTTP), or Socket Layer HTTP (SHTTP), thereby enabling customer service controller 102 to communicate with devices (such as travel organizer device 104, traveler device 106 and travel service provider device 108) over a network. In one embodiment, the Cold Fusion® Web Application Server from Allaire Corp.® is used along with the SQL database server from Microsoft Corp.®

The data stored in storage device 250 may be in a compressed, uncompiled and/or encrypted format. Furthermore, stored in storage device 250 may be program elements that may be necessary for operation of customer service controller 102, such as an operating system and “device drivers” for allowing microprocessor 205 to interface with devices in communication with communication port 215. These program elements are known to those skilled in the art, and need not be described in detail herein.

As used herein, information may be “received” by or “transmitted” to, for example: (i) customer service controller 102 and traveler device 106, travel organizer device 104 and travel service provider device 108; or (ii) a software application or module within customer service controller 102 from another software application, module, or any other source.

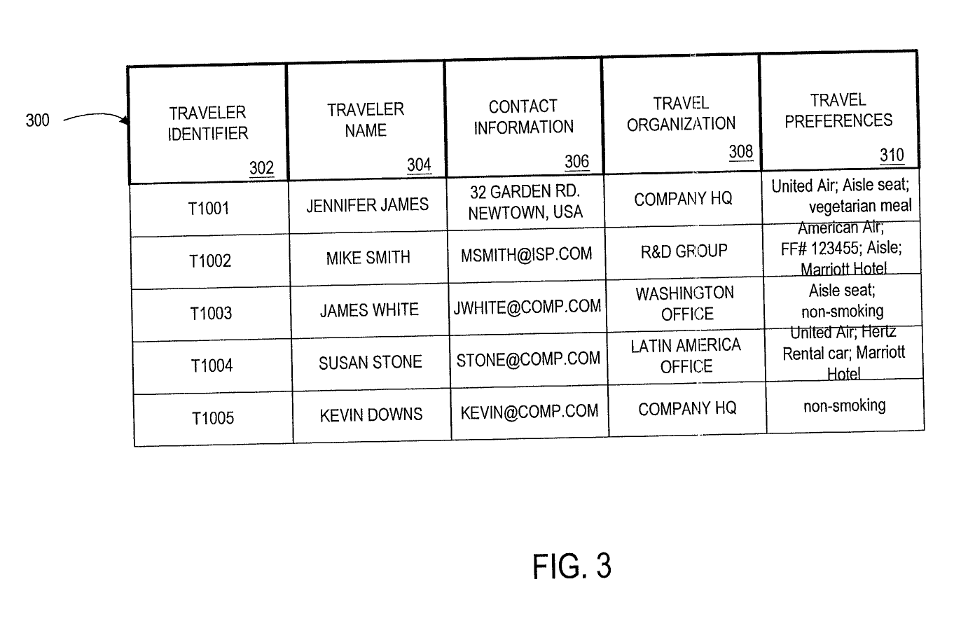

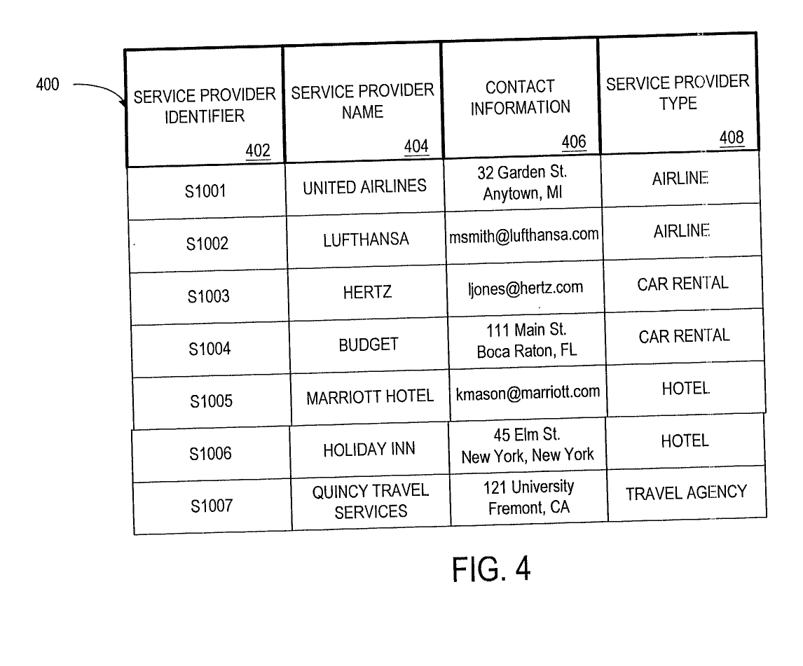

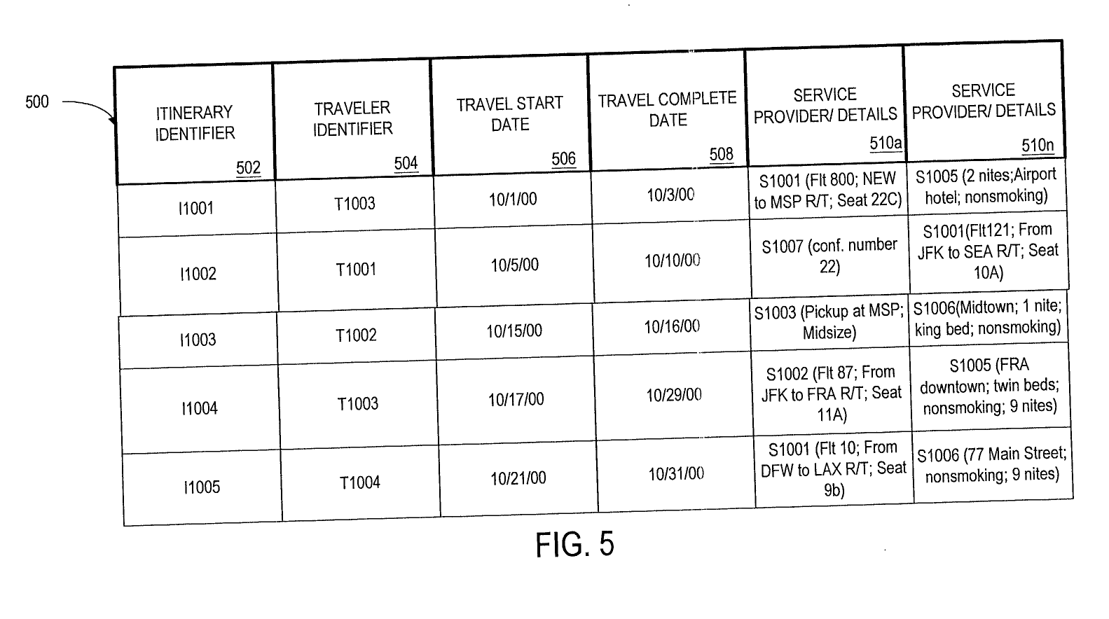

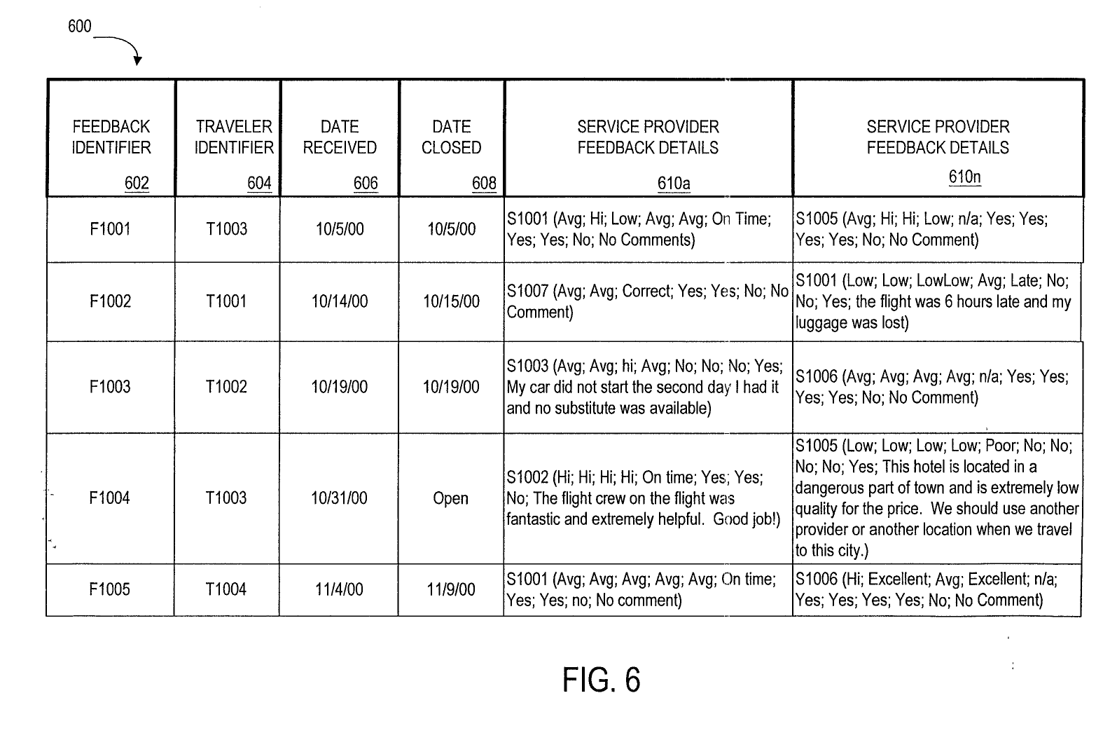

As shown in FIG. 2, storage device 250 also stores a traveler database 300 (described with respect to FIG. 3), a service provider database 400 (described with respect to FIG. 4), an itinerary database 500 (described with respect to FIG. 5), and a feedback database 600 (described with respect to FIG. 6). Examples of databases that may be used in connection with the system 100 will now be described in detail with respect to FIGS. 3-6. The illustrations and accompanying descriptions of the databases presented herein are exemplary, and any number of other database arrangements could be employed besides those suggested by the figures.

### Traveler Database

Referring to FIG. 3, a table represents traveler database 300 that may be stored at customer service controller 102 according to an embodiment of the present invention. The table includes entries identifying travelers who have provided, or who may provide feedback via system 100. The table also defines fields 302, 304, 306, 308, and 310 for each of the entries. The fields specify: a traveler identifier 302, a traveler name 304, contact information 306, a travel organization 308 and travel preferences 310. The information in the traveler database 300 may be created and updated, for example, based on information received from a traveler when he or she registers with the customer service controller 102. The information in the traveler database 300 may also be based on, for example, information generated after a traveler's travel plans result in a first travel itinerary as will be described below.

Traveler identifier 302 may be, for example, an alphanumeric code associated with a traveler who is registered to use the system 100 (e.g., by virtue of being a corporate traveler in an corporate travel program). Traveler identifier 302 may be generated by, for example, customer service controller 102. The traveler database 300 also stores traveler name 304 and contact information 306 (e.g., a postal address, an electronic mail address, an IP address, and/or a telephone number) associated with each traveler.

Travel organization 308 may be, for example, information identifying a corporate group with which the traveler identified by traveler identifier 302 is associated. This information may be used, for example, to generate reports and track information by corporate group (e.g., all feedback generated by employee-travelers from the “WASHINGTON D.C.” office of a company may be tracked). In one embodiment, travel organization 308 may be information identifying the company or other organization for which the traveler identified by travel identifier 302 is associated.

Travel preferences 310 may be, for example, information identifying specific travel preferences selected by the traveler identified by travel identifier 302. For example, travelers may identify a preference for: a particular airline, a particular frequent flier program, a particular type of meal, a seating preference, a particular hotel, a particular rental car company, etc. This information may be provided by the traveler or using information received from a travel organizer.

### Service Provider Database

Referring to FIG. 4, a table represents service provider database 400 that may be stored at customer service controller 102 according to an embodiment of the present invention. The table includes entries identifying travel service providers who have provided, or who may provide services to travelers who use system 100. The table also defines fields 402, 404, 406 and 408 for each of the entries. The fields specify: a service provider identifier 402, a service provider name 404, contact information 406, and a service provider type 408. The information in service provider database 400 may be created and updated, for example, using information from travel organizer 106 and service providers 108. The information in the service provider database 400 may also be based on, for example, information generated after a traveler's travel plans result in a travel itinerary which includes a new service provider (e.g., a service provider for which there is no information in service provider database 400).

Service provider identifier 402 may be, for example, an alphanumeric code associated with a service provider who provides services to travelers who utilize, or will utilize, system 100. Service provider identifier 402 may be generated by, for example, customer service controller 102. Service provider database 400 also stores service provider name 404 and contact information 406 (e.g., a postal address, an electronic mail address, an IP address, and/or a telephone number) associated with each service provider.

Service provider type 408 may be, for example, information identifying the type of services provided by the service provider identified by service provider identifier 402. This may be alphanumeric or numeric data used to categorize the different types of services, and may be assigned by an operator of customer service controller 102, for example. Types of services may include, for example: “AIRLINE”, “CAR RENTAL”, “HOTEL”, “TRAVEL AGENCY”, “RAIL”, “TAXI”, “LIMOUSINE SERVICE”, “CORPORATE HOUSING”, “FERRY SERVICE”, “BUS”, etc.

### Itinerary Database

Referring to FIG. 5, a table represents itinerary database 500 that may be stored at customer service controller 102 according to an embodiment of the present invention. The table includes entries identifying established travel itineraries of travelers whose feedback is to be tracked via system 100. The table also defines fields 502, 504, 506, 508, and 510a-n for each of the entries. The fields specify: an itinerary identifier 502, a traveler identifier 504, a travel start date 506, a travel end date 508, and service provider/details 510a-n. The information in the traveler database 500 may be created and updated, for example, based on itinerary information received from a travel organizer 104 such as a travel agency once the travel agency completes a travel itinerary for a traveler using the system 100. This data may be automatically received using any data transmission technique. For example, the data may be received using any global distribution system used in the travel industry (such as the Sabre® Virtually There Online® system, or the Worldspan® My Trip and More® system) or other direct database transfer system.

According to one embodiment, the information in itinerary database 500 is received by customer service controller 102 from travel organizer device 104 via an electronic mail message once an itinerary is established and forwarded to the traveler. For example, travel organizers 104 using the Sabre® Virtually There Online® system may provide itinerary information to customer service controller 102 by forwarding an electronic mail message generated by the Sabre® system to the customer service controller 102 in addition to sending the electronic mail message to the traveler.

Itinerary identifier 502 may be, for example, an alphanumeric code associated with an itinerary of a traveler who is using the system 100 (e.g., by virtue of being a corporate traveler in an corporate travel program). Itinerary identifier 502 may be generated by, for example, customer service controller 102, or it may be generated by travel organizer device 104, etc. Itinerary database 500 also stores traveler identifier 504 which may be retrieved from traveler database 300, or other information used to associate a particular traveler with the itinerary identified by itinerary identifier 502.

Itinerary database 500 also stores information identifying a travel start date 506 and a travel end date 508. This information may be used, for example, to determine when to solicit feedback from a traveler (e.g., after a particular trip is scheduled to be complete).

One or more sets of information identifying a service provider and details 510a-n are also provided in itinerary database 500. This information includes information identifying a particular service provider which is to provide travel services to the traveler on the trip associated with the itinerary identified by itinerary identifier 502. For example, an itinerary may include information identifying an airline service provider (with details such as the flights, flight times, seat numbers, meal requests, etc.), hotel service provider (with details such as the location of the hotel, number of nights requested, smoking preferences, and other room preferences, etc.), and a rental car service provider (with details such as the location of pickup, type of car, rate, number of miles, etc.).

### Feedback Database

Referring to FIG. 6, a table represents feedback database 600 that may be stored at customer service controller 102 according to an embodiment of the present invention. The table includes entries identifying feedback information received from travelers via system 100. The table also defines fields 602, 604, 606, 608, and 610a-n for each of the entries. The fields specify: a feedback identifier 602, a traveler identifier 604, a date received 606, a date closed 608 and service provider feedback details 610a-n. The information in the feedback database 600 may be created and updated, for example, based on information received from a traveler when he or she provides feedback information to customer service controller 102 using system 100.

Feedback identifier 602 may be, for example, an alphanumeric code associated with a set of feedback received from a traveler using system 100. Feedback identifier 602 may be generated by, for example, customer service controller 102. The feedback database 600 also stores traveler identifier 604 (e.g., the same as or corresponding to traveler identifier 302 of FIG. 3 discussed above). This information is used to associate feedback information received from a traveler with the particular traveler providing the feedback.

A date received 606 and a date closed 608 are provided to track the date when the traveler provided feedback and the date on which any resolution required by the feedback has been completed. For example, if a traveler lodges a complaint that requires follow-up by customer service controller 102 and/or travel service provider 108, the date closed 608 will not be entered until customer service controller 102 (or an operator of customer service controller 102) determines that the follow-up has been taken.

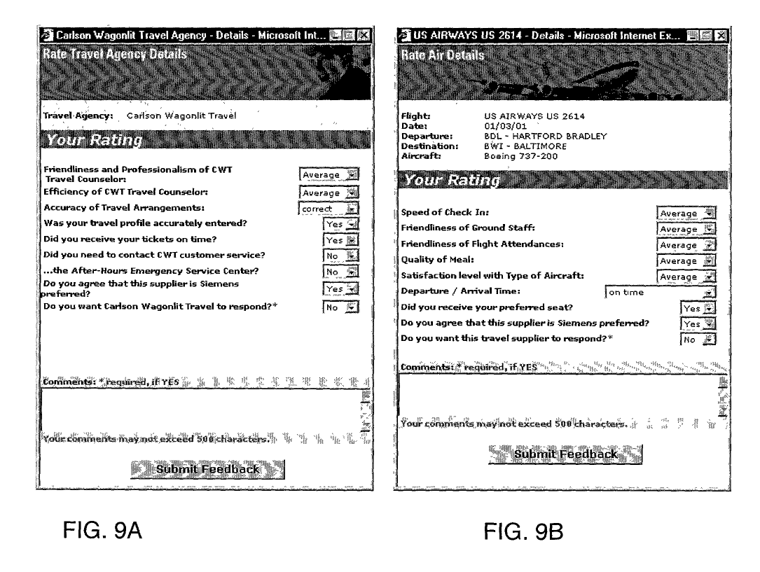

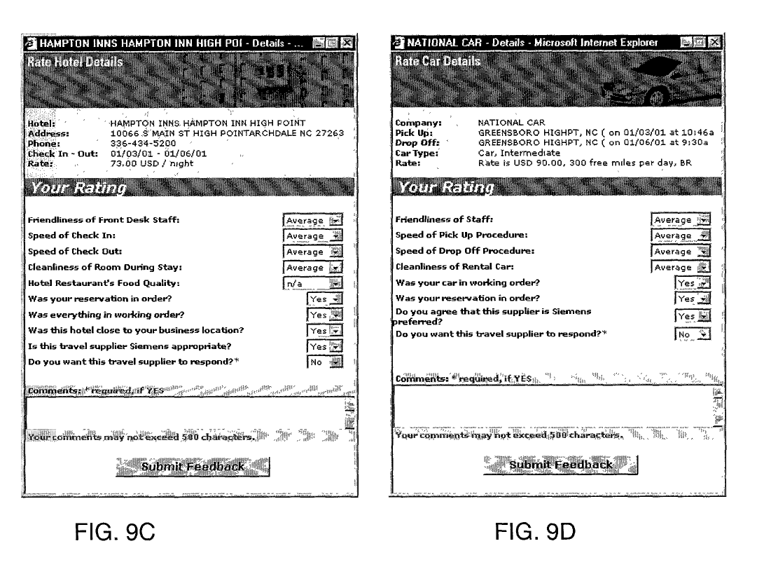

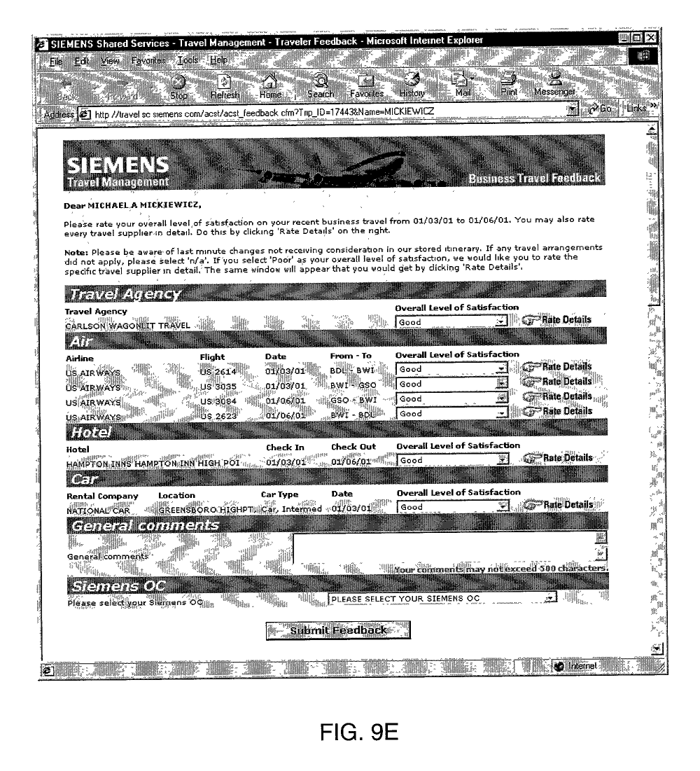

Feedback database 600 also includes service provider feedback details 610a-n including information identifying a service provider and information identifying feedback received from a traveler about the service provider. In one embodiment, this information is received in a standardized format, depending upon the service provider type 408 (stored, e.g., in service provider database 400 discussed in FIG. 4 above). For example, the information stored for an “AIRLINE” service provider may be responses to questions posed to a traveler in the format shown in FIG. 9A.

In one embodiment, this information is retrieved from a traveler by presenting the traveler with a Web-based form to fill out, ensuring consistency and standardization of presentation and response. Example Web-based forms are shown in FIGS. 9A-9D. A summary form may also be generated for each itinerary as well (FIG. 9E). In one embodiment, as shown in FIGS. 9A-9D, the traveler is also prompted to type in any comments or complaints he or she may have had about the travel supplier. In other embodiments, also as shown in FIGS. 9A-9D, travelers may be permitted to provide more free-form responses. Similar feedback requests are also presented to travelers for other service provider types 408, and the traveler's responses are stored in a consistent format in service provider feedback details 610a-n of feedback database 600.

In one embodiment, feedback details 610 are stored for each service provider providing service to a traveler on a particular itinerary (e.g., if there are three service providers providing service to a traveler on a particular itinerary, then there will likely be three separate service provider feedback details 610a, 610b, 610c in feedback database 600. In one embodiment, if a traveler chooses not to provide feedback information for a particular service provider, then default information, such as a null string “0000”, will be stored in each relevant feedback details field of feedback database 600).

### Process Description

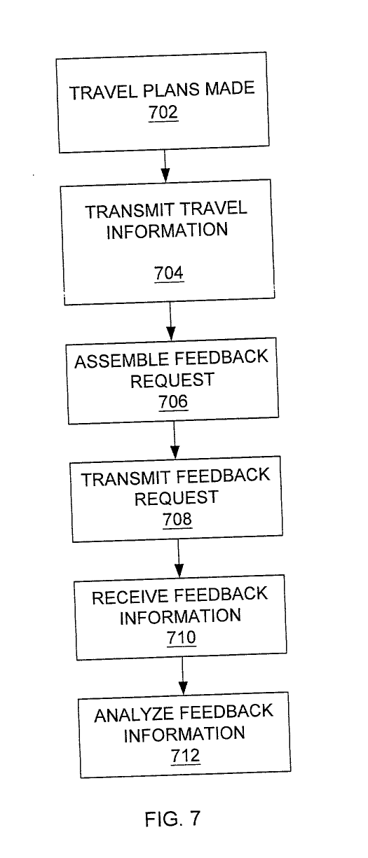

FIG. 7 is a flow chart of a method that may be conducted using the customer service controller 102 and system 100 according to an embodiment of the present invention. The flow charts in FIG. 7 and the other figures described herein do not imply a fixed order to the steps, and embodiments of the present invention can be practiced in any order that is practicable. Moreover, the methods may be performed by any one of, or combination of, the devices described herein.

At 702, a traveler's travel plans are made. In one embodiment, this is performed by a traveler 106 interacting with and using the services of a travel organizer 104. This interaction may be conducted electronically, e.g., over the Internet, or it may be conducted face to face or over the phone. Once the traveler's travel plans have been made, processing continues to 704, where travel information is transmitted. In one embodiment, this is performed using an electronic service such as the Sabre Virtually There® service where an electronic mail message is sent from Sabre® systems on behalf of the travel organizer 104 to the traveler 106. In addition, according to an embodiment of the invention, a similar, or duplicate electronic mail message is also sent to customer service controller 102. Other methods of transmitting travel information may also be used, so long as itinerary information needed to populate some or all of the itinerary database 500 (FIG. 5) is provided.

Processing continues at 706 where customer service controller 102 assembles a feedback request. In one embodiment, this is performed in a scheduled batch process which searches itinerary database 500 (FIG. 5) to determine which itineraries have been completed (e.g., by comparing the current date with the travel complete date 508). In one embodiment, feedback requests are assembled a short period (e.g., one or two days) after the scheduled travel complete date 508. The feedback request is assembled for each itinerary meeting the batch requirements, and includes, in one embodiment, a separate feedback form for each service provider who provided travel services to the traveler in the itinerary. For example, referring to the second record of itinerary database 500 of FIG. 5, the itinerary identified by itinerary identifier 502 “I1002” involved the services of two travel service providers, “S1007” and “S1001”. Accordingly, for this itinerary, customer service controller 102 will generate two separate feedback forms for each of the two service providers (one for a service provider of type “TRAVEL AGENCY” and one for a service provider of type “AIRLINE”). Example Web-based forms for such feedback are shown in FIGS. 9A-9D. A summary form may also be provided, summarizing the traveler's overall impression of the travel experience for that itinerary. An example summary form is shown in FIG. 9E. A new record in feedback database 600 is generated for the feedback request (FIG. 6).

Processing continues at 708 where the feedback request (including one or more feedback forms) is transmitted to traveler 106. In one embodiment, this is performed electronically by transmitting an electronic mail message to traveler 106. The electronic mail message may either contain each of the feedback forms or may simply include a link to a Web-site where the forms are posted for the traveler's use. By using automatically-generated forms such as the forms depicted in FIGS. 9A-9E, embodiments of the present invention simplify the process for the traveler by reducing the amount of information that he or she is required to input. Further, embodiments of the present invention allow the collection and aggregation of detailed and timely feedback from travelers.

The traveler 106, upon receiving the feedback request, responds to the feedback request and, if desired, adds extra comments and/or complaints to the feedback forms. In one embodiment, because the feedback form includes a number of questions which are customized for the particular type of service provider, the traveler simply needs to respond to each of the detailed questions to respond to the survey. This simplifies the process for the traveler, ensuring a larger number of responses from otherwise harried travelers. Each feedback form also includes space for detailed comments or complaints from travelers. Further, in one embodiment, each feedback form also includes a checkbox or entry which allows the traveler to specifically request follow-up by the service provider. Travelers may also be given the opportunity to add feedback for an additional travel service provider (e.g., where the traveler made changes to his or her itinerary during travel). This may include, for example, giving the traveler the ability to create a new feedback form by identifying the additional travel service provider by type (e.g., AIRLINE, etc.).

Upon completion of the feedback request, traveler 106 transmits the information and customer service controller 102 receives the feedback information at 710. Customer service controller 102 takes the feedback information, and stores it in feedback database 600 (FIG. 6). In one embodiment, feedback information for each service provider are stored separately in the database. The date that the information is received from the traveler is also stored in date received 606 field of the feedback database 600.

Upon receipt of the feedback information, customer service controller 102 analyzes the feedback information at 712. This analysis, in some embodiments, may include determining whether the traveler providing the feedback included any complaints or comments which require follow-up. For example, a traveler may specifically request that a service provider respond to a complaint by answering “YES” to the question “DO YOU WANT THIS TRAVEL PROVIDER TO RESPOND?” In other embodiments, comments received from a traveler are analyzed to determine the severity of the complaint or comment to determine if a response from the travel provider is necessary or beneficial. If a response or further follow-up is not required, or if it has been provided, the feedback record is “closed” by entering a date in the date closed 608 field of feedback database 600 (FIG. 6).

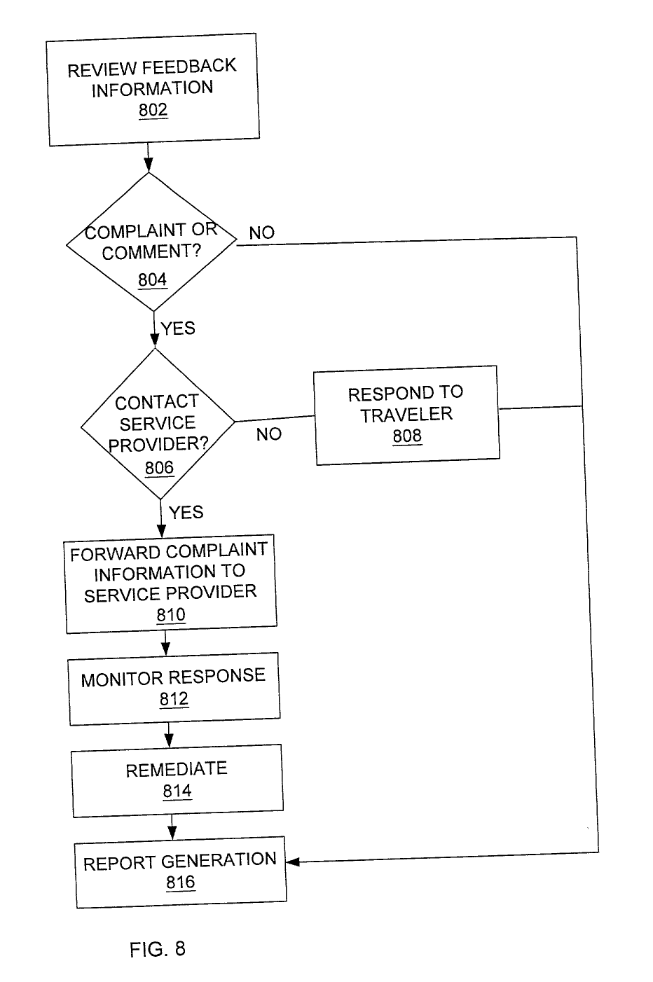

Referring now to FIG. 8, a flow diagram is depicted showing a more detailed complaint or comment resolution process according to one embodiment of the present invention. This process begins after receipt of feedback information from a traveler (which feedback information is generated and transmitted as discussed above in conjunction with FIG. 7). Feedback information is reviewed at 802. This review includes, for example, determining whether any particular complaint or comment was provided by the traveler in the feedback. For example, in embodiments where Web-based forms (such as the forms depicted in FIGS. 9A-E) are used, this review may include determining whether a separate comment or complaint was included in the text entry box. If the traveler provided no separate comment or complaint, or did not specifically ask for a response from the service provider, processing continues to 816 where reports may be generated (discussed further below).

If the traveler provided a separate comment or complaint, or specifically asked for a response from the service provider, processing continues to 806 where a determination is made whether customer service controller 102 (or an agent thereof) should contact the service provider. This may involve, for example, determining the severity or nature of the traveler's comment or complaint. The system may determine that certain types of comments or complaints need not require direct contact with the service provider on an individual traveler basis, but may require direct contact when there are a certain number of reoccurrences of the same complaint (e.g., an individual traveler's complaint that an airline was delayed may not warrant contact with the service provider; however, if nine out of ten travelers complain about that particular airlines delays may warrant contact with that airline). This allows a corporate travel organization or other heavy user of travel services to effectively redress complaints with travel service providers. Entities using embodiments of the present invention may use this aggregation and collection of feedback to negotiate better service agreements with travel service providers, negotiate better rates, and avoid using travel service providers who evoke an unreasonably large number of complaints or poor feedback.

If customer service controller 102 determines that there is no need to contact service provider at 806, processing continues to 808 where the traveler is responded to (e.g., with an electronic mail message or other type of message thanking the traveler for his or her feedback and explaining why the service provider was not contacted directly). Processing then continues at 816 where the feedback information is used in subsequent report generation.

If customer service controller 102 determines that there is a need to contact a service provider about a particular complaint, comment, or group of complaints or comments, processing continues at 810 where the information is forwarded to the service provider. This may be accomplished electronically (e.g., via an electronic mail message), via mail, or via telephone, etc.

Processing continues at 812 where customer service controller 102 monitors for a response from the service provider. The response may simply be an acknowledgement, apology, or explanation received from the service provider, or it may involve some action by the service provider (e.g., in the form of a service credit or rebate, etc.). If an acceptable response has not been provided, customer service controller 102 may transmit a reminder message to the service provider requesting further action.

Some issues may require some remediation by customer service controller 102 (at 814). For example, customer service controller may track the number of certain types of complaints lodged against individual service providers and seek improvement of the matters complained about. For example, if a TRAVEL AGENCY receives more than twenty complaints about quality of service in a short period of time, customer service controller 102 may forward the complaint information to the TRAVEL AGENCY until there is some sign of improvement in the quality of service (by monitoring subsequent feedback received by travelers using the TRAVEL AGENCY).

Processing continues at 816 where periodic reports are generated by customer service controller 102. These reports may be generated automatically or upon request, and may include summaries of data and data from the aggregated feedback received by travelers using the system. The data may be broken down in a wide variety of ways (e.g., by service provider, by traveler, by travel organization, etc.). Customer service controller 102 may automatically schedule specific queries of the stored data to produce reports which can be sent to travel managers (e.g., average rating per supplier, worst/best hotel, worst/best car rental location, etc.). In this manner, entities utilizing the system 100 according to embodiments of the present invention may more aggressively and responsively manage relationships with various travel service providers and ensure that their traveler's concerns and issues are addressed. The entire system can be configured to automatically generate feedback requests, ensuring that traveler's need enter only a minimal amount of information to complete feedback requests thereby increasing the number of completed and useful feedback requests that will be received. Travel suppliers benefit from the increased amount of detail received from the system.

Although the present invention has been described with respect to particular embodiments thereof, those skilled in the art will note that various substitutions may be made to those embodiments described herein without departing from the spirit and scope of the present invention.

For example, in the embodiment described above, feedback information is transmitted via Web-based forms. Other methods may also be used, including, for example, the use of cellular telephones operating using Wireless Application Protocol (WAP) compliant software. As another example, traveler's may submit their feedback information by interacting with a telephone Interactive Voice Response Unit (IVRU) which prompts them to respond to various feedback request. Custom comments or complaints may be input via a telephone keypad or by recording a voice message which can be translated using voice recognition software. Other methods and techniques may also be used.

In other embodiments, feedback received from travelers may be “posted” on a Web-site for viewing and further comment by other travelers. Other embodiments may automatically subscribe travelers to a newsletter, providing regular summaries of feedback received regarding various travel service providers to each traveler. In other embodiments, when customer service controller 102 receives travel information (e.g., at 704 of FIG. 7), it may perform actions such as: determining if an identified travel service provider's rates are compliant with the corporation's negotiated rate, and if not, seek resolution of the rate; determine if the traveler is entitled to participate in a travel service provider's rewards program and if the traveler is not already participating, assist the traveler in signing up for the rewards program; sign the traveler up for an automatic flight paging service if available; and determine whether one of the travel service providers has been blacklisted, and if so, ensure the traveler's plans are modified; distribute upgrade certificates for certain travel service providers; etc.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method for aggregating feedback, comprising:
receiving a first set of travel information including information identifying a traveler, an itinerary of said traveler, and at least one travel service provider scheduled to provide services to said traveler;
automatically generating a feedback request based on said first set of travel information and requesting specific feedback regarding said at least one travel service provider;
transmitting said feedback request to said traveler;
receiving feedback information from said traveler; and
analyzing said feedback information received from said traveler.

2. The method of claim 1, wherein said first set of travel information is received from a travel organizer.

3. The method of claim 2, wherein said analyzing further comprises:
determining whether at least a portion of said feedback information should be provided to said travel organizer.

4. The method of claim 1, wherein said automatically generating further comprises:
comparing a travel completion date from said first set of travel information to a current date; and
generating said feedback request when said current date is after said travel completion date.

5. The method of claim 1, wherein said automatically generating further comprises:
determining a type of said at least one travel service provider; and
generating said feedback request based on said type.

6. The method of claim 4, wherein said type is one of at least an airline, a car rental, a hotel, and a travel agency.

7. The method of claim 1, wherein said analyzing further comprises:
determining whether said feedback information includes a complaint.

8. The method of claim 7, wherein said analyzing further comprises:
determining whether said complaint requires a response from said at least one travel service provider.

9. The method of claim 8, wherein said analyzing further comprises:
monitoring said complaint to determine whether a satisfactory response from said at least one travel service provider has been received.

10. The method of claim 1, wherein said analyzing further comprises:
determining whether said feedback information includes a complaint.

11. The method of claim 1, wherein said analyzing further comprises:
determining whether at least a portion of said feedback information should be provided to said at least one travel services provider.

12. A computer-implemented method for aggregating feedback, comprising:
receiving a first set of travel information including information identifying a traveler, an itinerary of said traveler, and a plurality of travel service providers scheduled to provide services to said traveler;
generating a feedback request form for each of said plurality of travel service providers, requesting specific feedback based on each of said plurality of travel service providers;
generating a summary feedback request form requesting general feedback for said itinerary and each of said plurality of travel service providers;
transmitting each of said feedback request forms and said summary feedback request form to said traveler;
receiving feedback information from said traveler, including completed ones of said feedback request forms and said summary feedback request form; and
analyzing said feedback information received from said traveler.

13. The computer-implemented method of claim 12, wherein said first set of travel information is received from a travel organizer.

14. The computer-implemented method of claim 12, wherein said analyzing comprises:
reviewing information from each one of said feedback request forms and said summary feedback request form to determine whether any resolution is required.

15. The computer-implemented method of claim 12, wherein said analyzing comprises:
determining whether said feedback information received from said traveler includes a complaint.

16. The computer-implemented method of claim 12, wherein said analyzing comprises:
determining whether said feedback information received from said traveler includes a request for a response.

17. The computer-implemented method of claim 16, further comprising:
generating a request for a response from one of said travel service providers; and
monitoring said request for a response to determine if said travel service provider properly responds.

18. An apparatus for aggregating feedback, comprising:
means for receiving a first set of travel information including information identifying a traveler, an itinerary of said traveler, and at least one travel service provider scheduled to provide services to said traveler;
means for automatically generating a feedback request based on said first set of travel information and requesting specific feedback regarding said at least one travel service provider;
means for transmitting said feedback request to said traveler;
means for receiving feedback information from said traveler; and
means for analyzing said feedback information received from said traveler.

19. An apparatus for aggregating feedback, comprising:
a processor; and
a storage device in communication with said processor and storing instruction adapted to be executed by said processor to:
receive a first set of travel information including information identifying a traveler, an itinerary of said traveler, and at least one travel service provider scheduled to provide services to said traveler;
automatically generate a feedback request based on said first set of travel information and requesting specific feedback regarding said at least one travel service provider;
transmit said feedback request to said traveler;
receive feedback information from said traveler; and
analyze said feedback information received from said traveler.

20. A machine-readable medium having stored thereon data representing sequences of instructions, said sequences of instructions which, when executed by a processor, cause said processor to:
receive a first set of travel information including information identifying a traveler, an itinerary of said traveler, and at least one travel service provider scheduled to provide services to said traveler;
automatically generate a feedback request based on said first set of travel information and requesting specific feedback regarding said at least one travel service provider;
transmit said feedback request to said traveler;
receive feedback information from said traveler; and
analyze said feedback information received from said traveler.
